(19) United States
(12) Patent Application Publication
(10) Pub. No.: US 2008/0231579 A1
(43) Pub. Date: Sep. 25, 2008

(54) Motion blur mitigation for liquid crystal displays

(76) Inventors: Max Vasquez, Fremont, CA (US); Achintya Bhowmik, Milpitas, CA (US)

Correspondence Address: INTEL CORPORATION;c/o INTELLEVATE, LLC, P.O. BOX 52050, MINNEAPOLIS, MN, 55402, US

(21) Appl. No.: 11/726,912

(22) Filed: Mar. 22, 2007

(51) Int. Cl. G09G 3/36

(52) U.S. Cl. 345/98

(57) ABSTRACT

Visual quality of a liquid crystal display (LCD) panel is enhanced by combining black pixel insertion with response time correction (RTC) to mitigate motion blur. The black pixel insertion is performed during a portion of a current frame to establish a baseline for RTC in a next frame and therefore does not result in an increase in the frame rate of the LCD panel.

### FIELD

This disclosure relates to Liquid Crystal Displays (LCDs) and in particular to motion blur mitigation for LCD panels.

### BACKGROUND

A mobile computer typically includes a display device in the form of a low power Liquid Crystal Display (LCD) panel. A voltage is applied across liquid crystals in a liquid crystal layer in the LCD panel in order to illuminate pixels (picture elements), that is, discrete elements that together constitute an image. By controlling the voltage applied to each pixel, the amount of light allowed to pass through each pixel can be varied in order to display an image on the LCD panel.

The LCD panel may be used to display a static image or to view motion pictures (videos, movies). A motion picture is a sequence of static images (frames) that are projected on a screen in rapid succession. The location of the objects in successive frames is modified so as to produce the optical effect of a continuous picture in which the objects move.

However, one limitation to displaying motion pictures on a conventional LCD panel is motion blur that is visible on the display when displaying fast moving objects. Motion blur occurs due to slow response time of the liquid crystals, and hold-type characteristics of the LCD pixels.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system that includes an embodiment of a motion blur mitigator according to the principles of the present invention;

FIG. 2 is a block diagram of the system shown in FIG. 1 that includes an embodiment of a motion blur mitigator in a controller for mitigating motion blur in an LCD panel according to the principles of the present invention;

FIG. 3 is a graph illustrating drive level output from the motion blur mitigator shown in FIG. 2 and the corresponding luminance response; and

FIG. 4 is a block diagram of the LCD display shown in FIG. 2 that includes an embodiment of a motion blur mitigator according to the principles of the present invention.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

Due to the slow response time of the liquid crystals, the final intensity corresponding to the value of a pixel in the LCD panel may not be reached within the time period for displaying a frame (a frame time). Response time is the time a pixel takes to reach its final luminance within some tolerance after it is driven with a new pixel value. The response time varies widely in LCD panels, depending on the previous pixel value and the new value and is typically measured in milliseconds.

Response Time Compensation (RTC) is a technique used to decrease the response time in a sequence of frames that comprise a motion picture. RTC overdrives or underdrives a pixel value based on a pixel value for the current frame and the pixel value for the previous frame. RTC may be implemented in a Liquid Crystal Display (LCD) panel or a graphics controller that controls the display of frames for the LCD panel. If implemented in the LCD panel, the LCD panel includes a frame buffer to store pixel values for the previous frame and a two dimensional look-up table (LUT) to determine the required overdrive or underdrive for the pixel value. This additional frame buffer results in increasing the cost of the LCD panel.

If implemented in the graphics controller, the need for an additional frame buffer is avoided because the frame buffer in the graphics controller may be used. Also, the LUT is implemented within the graphics controller and may include overdrive or underdrive values in order to provide support for different types of LCD panels.

Thus, the LUT may be customized for each different type of LCD panel that is supported. However, the disadvantage of this scheme is that an additional frame buffer fetch is required per pixel in order to retrieve the pixel value for the previous frame in the sequence of frames. The additional frame buffer fetch results in increased power consumption.

Another characteristic of an LCD panel that contributes to motion blur is that a LCD panel is a hold-type display device, that is, a pixel value is displayed for the entire frame duration. In contrast, in an impulse-type display device such as a Cathode Ray Tube (CRT), a pixel value is displayed for a fraction of the frame duration. Thus, even if the response time of the LCD is reduced through RTC via overdriving or underdriving, motion blur may still occur due to the hold-type characteristic.

In order to minimize the motion blur resulting from the hold-type characteristic, some high-end LCD televisions blank the screen for a portion of the frame time by employing a double refresh rate, that is, a refresh rate of 120 Hertz (Hz) instead of at 60 Hz and inserting a black frame, known as Black Frame Insertion (BFI) or through the use of backlight shuttering. For BFI, the data is driven to the LCD pixels at twice the normal rate and a frame buffer is required on the display in order to convert the data from a 60 Hz rate to a 120 Hz rate. In backlight shuttering, the backlight is “blinked” for a portion of the frame. However, improving the motion blur due to hold-type characteristics remains limited to high-end (expensive) LCD televisions only, due to the extra costs in the LCD driving circuits (due to increased data rate) and frame buffer for BFI and in the LCD backlight control for backlight shuttering.

In an embodiment of the present invention, in contrast to backlight shuttering where a backlight is blanked for a portion of a frame, and BFI, where a black frame is inserted between frames, a pixel is driven to its associated pixel value for a portion of the frame and the pixel value is then driven to a value of zero (logical 0) for the remainder of the frame without the addition of a frame buffer. In order to further mitigate motion blur, response time correction (RTC) is also applied to provide an RTC adjusted pixel value to apply overdrive to the pixel value.

Driving the pixel value to logical 0 corresponds to displaying a “black” pixel. A black pixel is displayed for the remainder of the frame time prior to writing the next RTC adjusted pixel value for the next frame in the sequence of frames. Thus, the pixel value for each pixel is always logical 0 at the end of the current frame period prior to the start of a new frame period. This simplifies a LUT for applying overdrive or underdrive by reducing it from a two-dimensional LUT (previous and current frame) to a one dimensional LUT (current frame).

In one embodiment, the pixel value is driven to 0 during the frame period by a source driver in the LCD panel. In this embodiment with RTC implemented in the LCD panel, the need for a frame buffer for storing pixel values for the prior frame is eliminated. Furthermore, in this embodiment, by driving each pixel value to logical 0 for a remainder of the current frame prior to the start of the next frame, there is no increase in the refresh rate of the LCD panel as in BFI.

In another embodiment, the pixel value is driven to 0 by the graphics controller before applying a new pixel value. In this embodiment in which RTC is implemented in the graphics controller, the need for an additional frame buffer fetch is avoided. However, the refresh rate is increased.

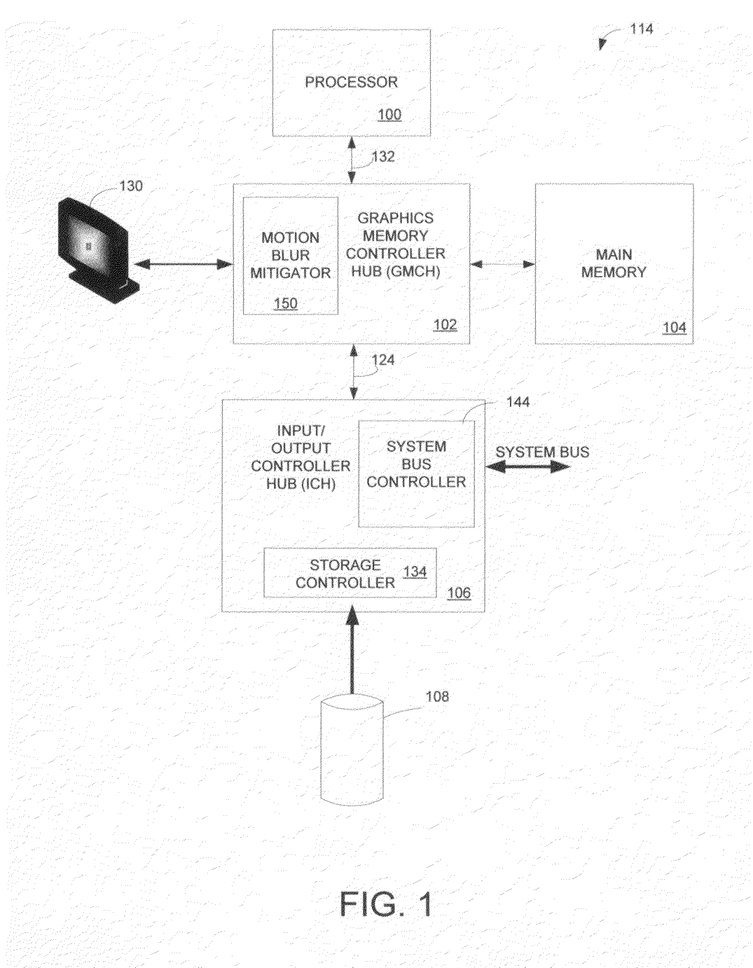

FIG. 1 is a block diagram of a system 114 that includes an embodiment of a motion blur mitigator 150 according to the principles of the present invention. The system 114 includes a processor 100 and a chipset that includes an Input/Output (I/O) Controller Hub (ICH) 106 and a Graphics Memory Controller Hub (GMCH) 102.

The GMCH 102 manages a memory 104 that is coupled to the GMCH 102. The system 114 may also include memory such as Dynamic Random Access Memory (DRAM), Static Random Access Memory (SRAM), Synchronized Dynamic Random Access Memory (SDRAM), Double Data Rate 2 (DDR2) RAM or Rambus Dynamic Random Access Memory (RDRAM) or any other type of memory.

The processor 100 is coupled to the GMCH 102 by a host interface 132. The GMCH 102 is coupled to the ICH 106 by a high-speed direct media interface 124. The ICH 106 may be coupled to the GMCH 102 using a high speed chip-to-chip interconnect 124 such as Direct Media Interface (DMI). DMI supports 2 Gigabit/second concurrent transfer rates via two unidirectional lanes.

The ICH 106 manages I/O devices including storage devices 108 coupled to a storage controller 134. In other embodiments the storage devices controlled by the ICH 104 may include a Digital Video Disk (DVD) drive, compact disk (CD) drive, Redundant Array of Independent Disks (RAID), or tape drive. The storage controller 134 may communicate with the storage devices using storage protocols such as Serial Advanced Technology Attachment (SATA), Fibre Channel, and Small Computer System Interface (SCSI).

The ICH 104 may also include a system bus controller 144 for controlling communication with other devices, for example, Network Interface Controllers. In one embodiment the system bus may be the Peripheral Component Interconnect (PCI) or the Peripheral Component Interconnect Express (PCI-e) bus.

The GMCH 102 may include a graphics controller for controlling a display device such as a Liquid Crystal Display (LCD) panel 130 coupled to the GMCH 102. In the embodiment show, a motion blur mitigator 150 is included in the graphics controller in the GMCH 102 to mitigate motion blur in the display. In another embodiment, a motion blur mitigator may be included in the LCD panel 130.

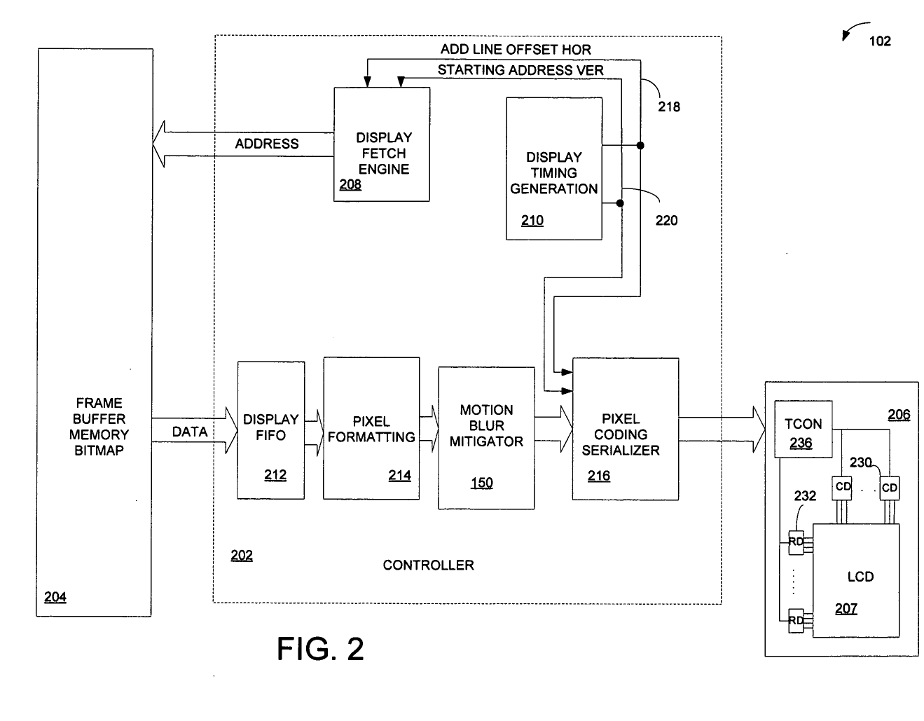

FIG. 2 is a block diagram of the system shown in FIG. 1 that includes an embodiment of a motion blur mitigator 150 in a controller 202 for mitigating motion blur in an LCD panel according to the principles of the present invention.

In the embodiment shown, the controller (“graphics controller”) 202 is included in the GMCH 102 shown in FIG. 1. Graphics controller 202 generates image data for display by LCD display 206. The image data may be for a video (sequence of images) with high motion content. The graphics controller 202 is coupled to an LCD display 206 for transmitting image data (frames) for display on the LCD display. Frames to be transmitted by the controller 202 are stored in a frame buffer memory bitmap 204 which may be a portion of memory 104 (FIG. 1) coupled to the GMCH 102 (FIG. 1). A motion blur mitigator 150 in the controller 202 mitigates motion blur by driving a pixel value to logical 0 to display a pixel having minimum brightness (“black pixel”) during a portion of a current frame period prior to applying a new overdrive value to the pixel for a subsequent frame period.

The motion blur mitigator 150 may also include a Response Time Compensation (RTC) module to apply Response Time Compensation (RTC) to image data. The RTC module determines the final drive level to the panel, that is, the overdrive or underdrive or whether to allow the pixel to pass with neither over or under drive applied. For example, no compensation may be applied if a black (zero luminance) pixel can not be inserted because the LCD display 206 does not support a high refresh rate.

In one embodiment, the controller 202 operates at a 2× frame rate and the black pixel is generated by not fetching any data from frame buffer memory bitmap 204 for the “black” frame. Instead of fetching data from the frame buffer bitmap 204, the black pixel values are generated by the motion blur mitigator 150.

In other embodiments, the black pixel value may be generated in the display FIFO 212, pixel formatting 214 or even in frame buffer memory bitmap 204. However, in these embodiments there may be a resulting increase in power consumption. In yet another embodiment, the motion blur mitigator 150 may drive a value of logical 0 on the output.

In some embodiments, controller 202 may include a frame buffer memory bitmap 204 for storing image data (frames) and a display fetch engine 202 for generating a frame buffer memory address and control signals to obtain a next frame to be displayed on the LCD panel 204. The image data from frame buffer memory bitmap 204 is processed through display First In First Out (FIFO) 212, pixel formatting 214, motion blur mitigator 150 and pixel coding serializer 216 to provide frames of pixels over interface 112 for display panel 206. Motion blur mitigator 150 may perform response time compensation to provide compensated pixel values that may compensate for a slower response time of the elements of LCD panel 206. Controller 202 may also include display timing generation 210 to generate and/or provide clock signals and/or other timing signals for use within controller 202. In the embodiment shown, display timing generating 210 generates Address line Offset Horizontal signal 218 and starting address vertical signal 220 used by the display fetch engine 202 to select frames stored in the frame buffer memory bitmap 204 and by the pixel coding serializer 216 to transmit frames to the LCD display 206.

In the embodiment shown, LCD display 206 includes row drivers 232 and column drivers 230, for providing signals to drive and/or control the individual elements (pixels) of display 134. The LCD display includes an LCD panel 207 and a Thin Film Transistor (TFT) LCD Timing Controller (TCON) 236. The TCON 236 controls timing for row drivers (RD) 232 and column drivers (CD) 230 based on pixel data and LCD timing control signals received from the controller 202 to control the display of each frame on display panel 207. Each pixel in the LCD panel 207 may have an associated column and row address allowing it to be refreshed independently.

In an embodiment the controller 202 is coupled to the LCD display 206 through a Low Voltage Differential Signaling (LVDS) Display Interface (LDI). LDI includes signals to enable panel power and to control the brightness of the panel backlight. LVDS is an electrical standard that defines driver output characteristics and receiver input characteristics. Data may be transmitted serially over the interface to the LCD display 206, seven bits at a time per data signal.

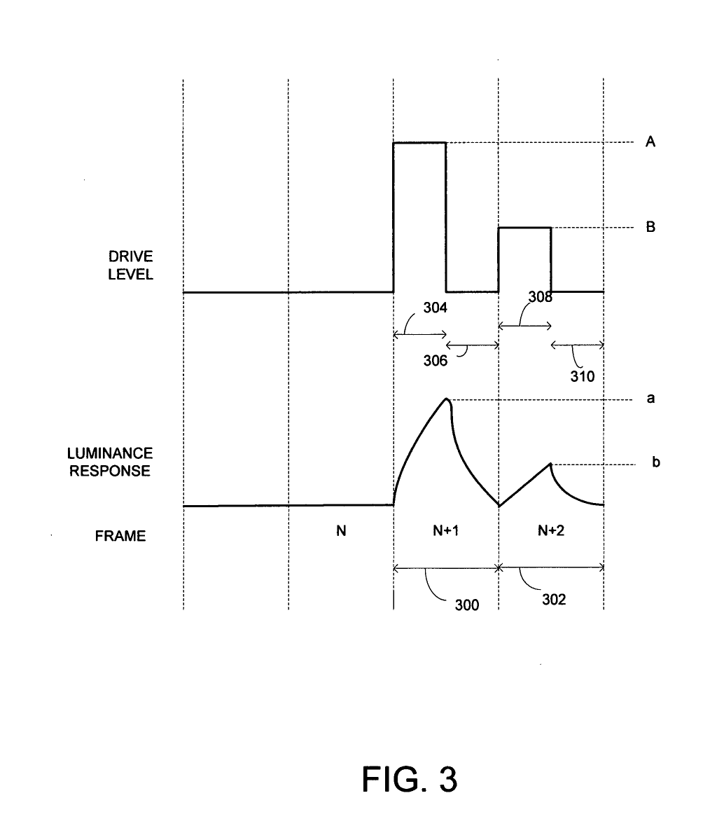

FIG. 3 is a graph illustrating drive level output from the motion blur mitigator shown in FIG. 2 and the corresponding luminance response.

As shown, in FIG. 3, at frame N+1, RTC applies compensation to the pixel to overdrive the pixel value, that is, to drive pixel to desired level. In one embodiment, the motion blur mitigator 150 in the controller 202 may break up each frame as shown into two fields or subframes. During one of the fields the frame data is displayed and during the other field the data is logical 0. Thus, each pixel has a valid data value in one field and a logical 0 value in the other field. In an embodiment in which each field is half of a frame period, as shown in the embodiment in FIG. 3, a pixel is logical 0 (“black”) for about 50% of the frame and has valid data for about 50% of the frame period. Thus, the pixel is overdriven based on the pixel value for about 50% of the frame and a pixel value of logical 0 is transmitted to the LCD panel 206 for about the other 50% of the frame.

Referring to FIG. 3, during frame period 300, valid pixel data with luminance value of a is overdriven to drive level A for portion 304 of the frame period 300 and driven to logical 0 for portion 306 of the frame period 300. During frame period 302, valid pixel data with luminance response b is overdriven to drive level B for portion 308 of frame period 302 and is driven to logical 0 for portion 310 of frame period 302.

Thus, motion blur is mitigated because the intended level (a, b) of the pixel value is reached within the time frame and the luminance response mimics the impulse-type behavior of a Cathode Ray Tube (CRT) by driving the pixel value to logical 0 for a portion of the frame period. Furthermore, the LUT is also greatly simplified because the pixel value for the current frame before the pixel value for the next frame, is always logical 0. This reduces the need for a two-dimensional LUT needed for RTC to a 1-dimensional LUT because only the pixel value for the current frame is required as the prior frame is always logical 0. The RTC LUT may also be eliminated in certain embodiments by combining it with the existing gamma table in the LCD panel, with values stored in the gamma table used to code luminance values in frames, thereby significantly reducing the complexity.

The combination of RTC and insertion of a black pixel for a portion of the current frame period prior to the start of a next frame period is effective at mitigating motion blur caused by both slow response time and hold-type characteristics of the LCD panels. The combination also makes the pixel luminance response much more like the pixel luminance response of a pixel in a Cathode Ray Tube (CRT).

In an embodiment in which the insertion of a black pixel value for a portion of a current frame period is implemented in the panel, the double refresh rate is not required. Thus, this embodiment may be more easily implemented in LCD panels that are used in mobile computers such as notebook computers.

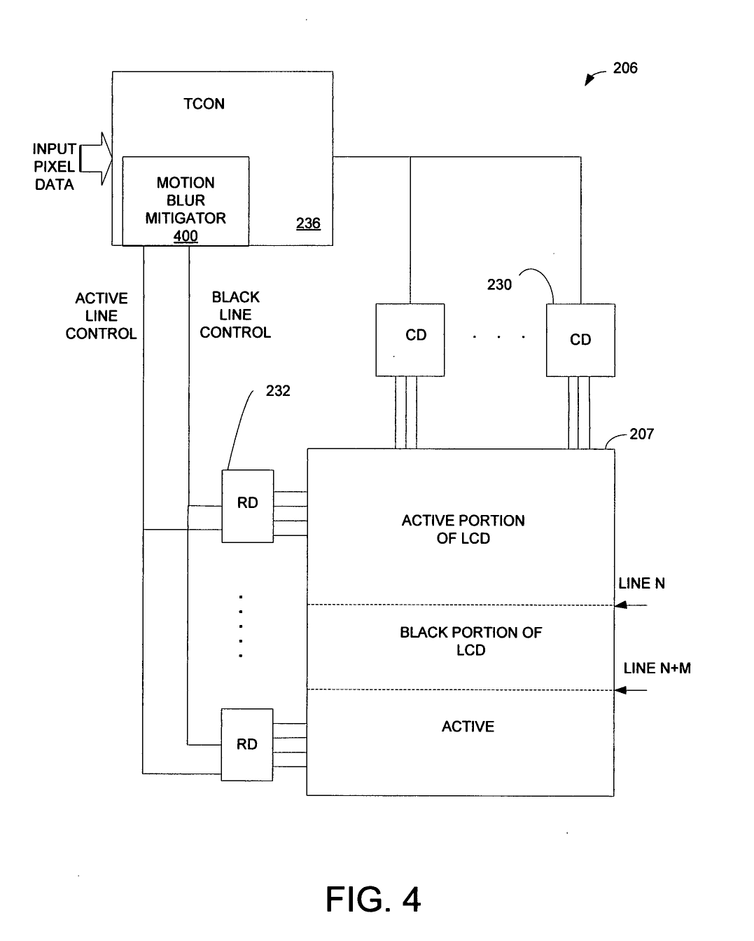

FIG. 4 is a block diagram of the LCD display shown in FIG. 2 that includes an embodiment of a motion blur mitigator 400 according to the principles of the present invention.

In the embodiment shown, the motion blur mitigator 400 is included in the LCD Timing Controller (TCON) 236. The LCD panel 206 writes a line at a time by first shifting the pixel values for a line into the column drivers 230 and then activating the row driver 232 for the line to be written. The lines are written sequentially by increasing line number, with the top line written first and the bottom line written last.

The motion blur mitigator 400 applies RTC and determines which lines in the LCD panel 206 to drive to black. In the embodiment shown, a line is driven to black by the row drivers 232 dependent on the state of a black line control signal controlled by the motion blur mitigator 400. However, in other embodiments a line may be driven black using a method that does not use the row drivers 232.

The TCON 236 drives line N+M to black while line N is driven with the active pixel data. Line N is the last active line of data, before the first black data line. Line N+1 is the first black line of data and line N+M is the last black line of data. M is the number of lines that are black at any given time. The remaining lines are active lines with valid data. In one embodiment, M may be configurable by the motion blur mitigator 400. If N+M is greater than the number of lines in the display, then the lines at the top of the screen are driven to black, modulo the number of lines in the display. For instance if there are 800 lines in the display and N+M is equal to 801, then line 1 is driven to black. Similarly, if N+M equals 819, then line 19 is driven to black.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. An apparatus comprising:
processing circuitry to apply a response time correction to drive a pixel to a threshold voltage level corresponding to a pixel value during a first portion of a frame period; and
logic to drive the pixel value to logical 0 for a remaining portion of the frame period.

2. The apparatus of claim 1, wherein the threshold voltage level corresponds to an overdrive value corresponding to the pixel value and logical 0.

3. The apparatus of claim 1, wherein the threshold voltage level corresponds to an underdrive value corresponding to the pixel value and logical 0.

4. The apparatus of claim 1, wherein the overdrive value stored in a lookup table and selected to achieve a desired luminance response on a display.

5. The apparatus of claim 1, wherein the underdrive value stored in a lookup table is selected to achieve a desired luminance response on a display.

6. The method of claim 1, wherein the first portion is half of the frame period.

7. The method of claim 1, wherein the first portion includes a configurable number of display lines in the LCD display.

8. A method comprising:
applying a response time correction to drive a pixel to a threshold voltage level corresponding to a pixel value during a first portion of a frame period; and
driving the pixel value to logical 0 for a remaining portion of the frame period.

9. The method of claim 8, wherein the threshold voltage level corresponds to an overdrive value corresponding to the pixel value and logical 0.

10. The method of claim 8, wherein the threshold voltage level corresponds to an underdrive value corresponding to the pixel value and logical 0.

11. The method of claim 8, wherein the overdrive value stored in a lookup table and selected to achieve a desired luminance response on a display.

12. The method of claim 8, wherein the underdrive value stored in a lookup table is selected to achieve a desired luminance response on a display.

13. The method of claim 8, wherein the first portion is half of the frame period.

14. The method of claim 8, wherein the first portion includes a configurable number of display lines in the LCD display.
